(19) United States
(12) Patent Application Publication
(10) Pub. No.: US 2026/0262586 A1
(43) Pub. Date: Sep. 10, 2026

(54) SAW HEAD WITH AUTONOMOUS STUMP TREATMENT SYSTEM

(71) Applicant: Deere & Company, Moline, IL (US)

(72) Inventors: Girish S. Chute, Pune (IN); ANTONY M. RAJ, Coimbatore (IN); RAHUL A. CHOUREY, Pune (IN); CHANDRASHEKAR R. ANANTHPUR, Pune (IN)

(21) Appl. No.: 19/074,558

(22) Filed: Mar. 10, 2025

(51) Int. Cl. A01G 23/091; A01G 23/099

(52) U.S. Cl. CPC A01G 23/091; A01G 23/099

(57) ABSTRACT

A felling head with autonomous stump treatment system having a saw head that can automatically apply a herbicide to a tree stump when it detects that its saw blade is cutting a tree. The saw head can include a motor coupled to the saw blade, a sensor that monitors a current rotational speed of a drive shaft that couples the motor to the saw blade, and a controller actuated dispenser for dispensing a herbicidal fluid. The saw head can be coupled to a controller that is configured to monitor a signal from the sensor and determine a difference between a target speed of the drive shaft and a current speed of the drive shaft. The controller can actuate the dispenser and apply the herbicidal fluid to a tree stump when the current speed difference reaches a threshold value.

### FIELD OF THE DISCLOSURE

The present disclosure relates generally to a saw head with an autonomous tree stump treatment system and, more specifically, to a saw head that can autonomously apply herbicide to a tree stump when it detects the saw blade is cutting a tree.

### BACKGROUND

Forestry equipment, such as feller bunchers and harvesters equipped with felling heads, or harvesting heads, can be used to fell and harvest large numbers of trees within a relatively short period. Felling heads and harvesting heads can include saw heads with motor driven disk saws or blade saws that are continuously powered during the harvesting or felling job. Felling heads and harvesting heads can also include harvesting arms and/or bunching arms designed to gather and accumulate multiple trees. They are designed so that an operator can fell a tree while holding several previously felled trees between bunching and felling arms.

Some trees, such as eucalyptus, have tree stumps that quickly regenerate after the main tree trunk has been harvested. Trees such as these should preferably be treated with a herbicide within 12-14 hours of harvesting to prevent regeneration. To avoid requiring a second separate time-consuming and costly operation to treat such tree stumps, some feller bunchers can include a herbicide dispensing system that an operator can actuate to dispense herbicide during a felling operation. These systems require an operator to identify when a tree is being felled and to dispense herbicide onto the freshly cut tree stump. However, they can be inefficient. Operators can fail to apply herbicide to some tree stumps and can apply excessive amounts of herbicide to others causing significant waste and requiring a second team of personnel to identify and apply herbicide to untreated stumps. Because these current systems are unable to reliably detect when the saw head is cutting a tree and autonomously apply herbicide to the remaining stump, a need still exists for a saw head with autonomous stump treatment system.

### SUMMARY OF THE DISCLOSURE

One embodiment directed to a saw head for treating tree stumps can include a planar saw having a plurality of teeth along a saw edge. The saw edge separates a shaft side of the saw from a stump side and includes a cutting edge. The plurality of teeth includes advancing teeth and returning teeth which are coupled to a motor via a drive shaft on the shaft side. The motor is configured to drive the advancing teeth towards the cutting edge and the returning teeth away from the cutting edge with a target drive shaft speed. The saw head also includes a sensor configured to monitor a current drive shaft speed and to output a signal responsive to the current drive shaft speed. The saw head further includes a controller-operated fluid dispenser configured to dispense a fluid adjacent to the cutting edge. The saw head can be coupled to a controller that is communicatively coupled to receive the signal from the sensor and operatively coupled to operate the dispenser. The controller is configured to dispense the fluid based on a current speed difference between the target drive shaft speed and the current sawing speed. Optionally, the controller can be configured to dispense fluid when the current speed difference is at least 5%, and preferably at least 10% of the target drive shaft speed.

According to one aspect, the saw head can also include a saw guard with a first branch that shrouds advancing teeth and a second branch that shrouds returning teeth. The saw edge includes a guarded edge that is separate from the cutting edge that is shrouded by the saw guard and the first branch includes a dispenser outlet. The motor can be configured to drive the plurality of teeth in a cutting direction, and the dispenser outlet can be configured to spray the fluid in the cutting direction towards the cutting edge. Optionally, the fluid can be a herbicide. The saw head's dispenser can include a fluid reservoir fluidly coupled to a dispenser outlet and can further include a pump configured to pump fluid from the fluid reservoir through the dispenser outlet. According to another aspect, the controller can be operatively coupled to the pump and configured to operate the pump to adjust a flow rate of the fluid dispensed through the dispenser outlet. A controller operated valve can be operatively coupled to the controller. The controller can be configured to operate the valve to adjust a flow rate of fluid dispensed through the dispenser.

In another embodiment, a saw head for treating tree stumps can include a frame which extends between an upper end a lower end, a motor attached to the frame and coupled to rotate a drive shaft about a central longitudinal axis of the drive shaft. The drive shaft includes a mount below the motor relative to the frame for attaching a transverse saw blade to rotate with the drive shaft. The saw head also includes a harvesting arm pivotally attached to the frame above the mount relative to the frame, a harvesting cylinder coupled between the harvesting arm and frame and actuatable to pivot the harvesting arm transversely between an open and closed position. The saw head additionally includes a saw blade guard transversely mounted on the frame below the harvesting arm the saw blade guard extending transversely, a sensor configured to monitor a current rotational speed of the motor and to output a signal responsive to the current speed of the motor and a controller operated fluid dispenser configured to dispense a fluid. The saw head can be coupled to a controller that is communicatively coupled to receive the signal from the sensor and operatively coupled to operate the dispenser. The controller can be configured to dispense the fluid based on a current speed difference between the target drive shaft speed and the current drive shaft speed. A dispenser outlet can be mounted on the guard. Optionally, the controller can be configured to dispense fluid when the current speed difference is at least 5% and, preferably, least 10% of the target drive shaft speed. According to a further option the fluid can be a herbicide. As a further option the dispenser can include a fluid reservoir fluidly coupled to the dispenser outlet. According to a still further option, the dispenser can include a pump configured to pump fluid from the fluid reservoir to the dispenser outlet.

### BRIEF DESCRIPTION OF THE DRAWINGS

The detailed description of the drawings refers to the accompanying figures in which:

FIG. 1 is a side elevation view showing a simplified forestry vehicle including a base vehicle and a disk saw felling head attached to the base vehicle for manipulation thereby;

FIG. 2 is a lower oblique perspective view of the disk saw felling head of FIG. 1;

FIG. 3 is an upper oblique perspective view of the disk saw felling head of FIG. 1 with a cutaway of the saw head;

FIG. 4 is a front cross sectional view of the lower portions of the disk saw felling head of FIG. 1;

FIG. 5 is a schematic view of one embodiment of a control system of a saw head coupled to a base vehicle; and

FIG. 6 is a flow chart of one embodiment of an algorithm for configuring a controller suitable for the control system of FIG. 5.

FIG. 7 is a graph showing the rotational speed of a saw blade rpm over time during felling.

### DETAILED DESCRIPTION

According to one embodiment, a saw head for treating tree stumps can include a motor coupled to drive a saw for felling trees and a herbicide dispensing system that can be controlled to apply a herbicidal fluid to a sawn surface of a tree stump. The motor can be any type of suitable motor such as a hydraulically powered or electrically powered motor. The saw can be any of the known types of saws designed to be powered by a motor, such as a disk saw or a bar saw. Such saws can include a saw blade having a plurality of cutting teeth arranged along a saw edge. The saw blade is generally planar with a saw edge separating a shaft side of the saw blade from a stump side. A mandrel or drive shaft can couple the motor to the shaft side of the saw blade so that when powered, the motor drives the shaft to rotate the cutting teeth around saw edge.

The saw blade of a disk saw for felling trees can be a circular, substantially planar disk with cutting teeth distributed. The saw blade can be attached to a shaft that extends generally perpendicularly from the shaft side of the disk. The shaft fixably couples the saw blade to rotate with an output shaft of the motor so that when powered, the motor rotates the cutting teeth on the saw edge of saw blade disk. Alternatively, the saw blade of a bar saw can include a saw bar, which is a substantially planar and generally oval plate, surrounded by a saw chain on the peripheral edge of the saw bar that separates the shaft side from the stump side. The cutting teeth of the saw chain form the saw edge. The saw chain includes links that are cutting teeth. A sprocket wheel lying in or adjacent to the plane of the saw bar and coupled to engage the saw chain at one end of the saw bar, can be attached to a mandrel or drive shaft that extends from the shaft side of the saw blade. The mandrel can couple the sprocket to the motor output shaft so that when powered, the motor drives the mandrel to rotate the saw chain and cutting teeth around the saw bar. The linear speed at which the cutting teeth travel along the saw bar and move through a cut is the sawing speed. The sawing speed is generally proportional to the rotational speed of the drive shaft both in disk saws and in bar saws.

With the motor rotating the cutting teeth of the disk saw or bar saw, an operator can operate the forestry machine so that a portion of the saw edge engages and begins to cut a trunk or limb of a tree. The portion of the saw edge that engages the tree and forms a cut is the cutting edge. The dispensing system in the saw head can include a dispensing outlet positioned and configured to release, spray, or otherwise dispense a herbicidal fluid such that the fluid is deposited on the cutting edge and sawn surfaces of the stump of the tree.

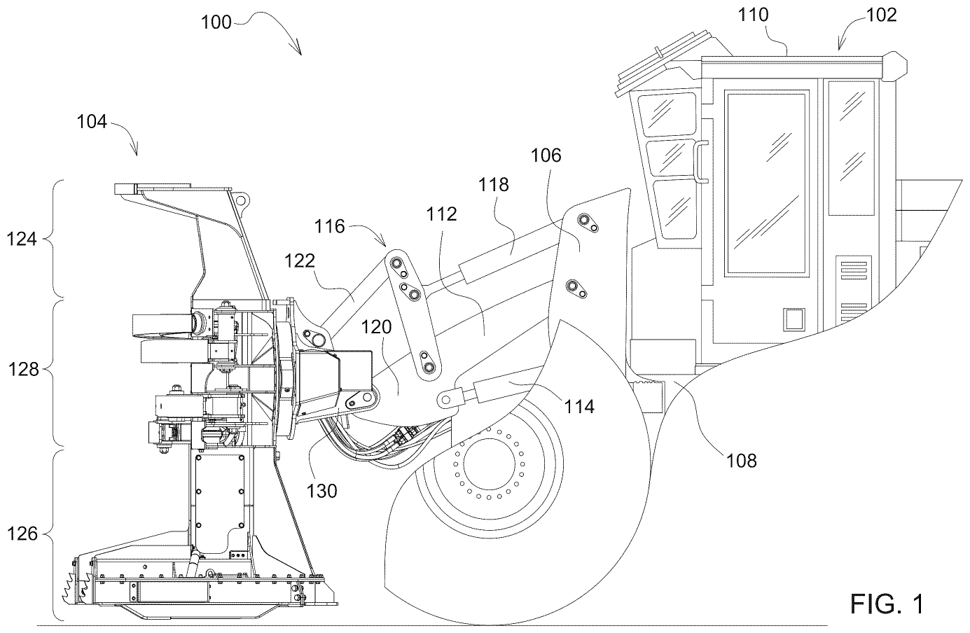

Referring to FIG. 1, a forestry machine 100 includes a base vehicle 102, such as a mobile machine with wheels or tracks, and a disk saw felling head 104 attached to the base vehicle 102 to be manipulated and controlled thereby. The disk saw felling head 104 is configured to fell trees and to accumulate them for subsequent processing.

The base vehicle 102 has a front frame 106, a rear frame 108, an operator's station 110, a boom 112, a pair of hydraulic lift cylinders 114 (left and right, the left shown and representative of the right), a pivot linkage 116, and a pair of hydraulic pivot cylinders 118 (left and right, the left shown and representative of the right). The front frame 106 and the rear frame 108 are articulated to one another for relative pivotable movement therebetween about an articulation axis. The operator's station 110 is mounted to the rear frame 108. Boom 112 is attached pivotally to the front frame 106, and felling head 104 is attached pivotally to the boom 112. The lift cylinders 114 are attached to the front frame 106 and the boom 112 to raise and lower the boom 112, and thus felling head 104, relative to the front frame 106. The pivot linkage 116 is attached pivotally to boom 112 and felling head 104. The pivot cylinders 118 are attached to the boom 112 and the linkage 116 to pivot the linkage 116, and thus felling head 104, forwardly and rearwardly relative to the boom 112.

Boom 112 includes a left or first boom arm 120 and a right or second boom arm 120, the first boom arm 120 shown and representative of the second boom arm 120. The first boom arm 120 and the second boom arm 120 are attached pivotally to the front frame 108 and attached pivotally respectively to mounting bracket 130 of felling head 104. The lift cylinders 114 are attached respectively to the boom arms 120. The pivot linkage 116 includes a left or first link 122 and a right or second link 122, the first link 122 shown and representative of the second link 122. The first link 122 and the second link 122 are attached pivotally respectively to mounting bracket 130.

Felling head 104 can include an arm section 128 positioned between a saw-and-motor section, or saw head 126, and a horn section 124. Referring to FIGS. 1-3, felling head 104 has a fore-aft dimension 202A, a lateral dimension 202B, and a vertical dimension 202C. The fore-aft dimension 202A, the lateral dimension 202B, and the vertical dimension 202C are perpendicular to one another. Felling head 104 can include a frame 208 with structural members such as a spine 210 which extends vertically relative to the vertical dimension 202C, and a mounting bracket 130. Horn section 124, saw head 126, and arm section 128 can be rigidly attached to spine 210 which fixes them in their relative position in felling head 104. Mounting bracket 130 can also be rigidly attached to spine 210 and provides a mounting point to couple base vehicle 102 to felling head 104 via boom 112 and linkage 116. Saw head 126 can be attached (e.g., welded) to a bottom portion of spine 210. The horn section 124 is attached (e.g., welded) to an upper portion of frame 208 above the arm section 128 relative to the vertical dimension 202C.

Referring to FIGS. 1-3, arm section 128, includes a harvesting arm 204, pivotally attached to frame 208. An actuator, such as a hydraulic cylinder can be coupled between the harvesting arm 204 and frame 208 and can be controlled by an operator to pivot harvesting arm 204 transversely between an open position and a closed position. Arm section 128 also includes a bunching arm 206 pivotally attached to frame 208. An actuator, such as a hydraulic cylinder can be coupled between the bunching arm 206 and frame 208 and can be controlled by an operator to pivot bunching arm 206 transversely between an open position and a closed position. The arms 204, 206 and the cylinders are positioned between the motor housing 214 and the horn section 124 relative to the vertical dimension 202C.

During a felling job, operation of the harvesting arm 204 and the bunching arm 206 is coordinated in order to receive and accumulate felled trees. The harvesting arm 204 is opened in order to receive a tree onto a butt plate of the saw guard 218 upon felling. The harvesting arm 204 is closed to move the newly felled tree into a pocket of horn section 124. Meanwhile, the bunching arm 206 is closed in order to hold any previously felled trees in the pocket. Once the harvesting arm 204 moves a newly felled tree over to the pocket, the bunching arm 206 is opened so as to move out and around the newly felled tree in order to hold the newly felled tree with any other felled tree(s) in the pocket. The bunching arm 206 is segmented into a first segment attached pivotally to the frame 208 and a second segment attached pivotally to the first segment and spring-biased to an open position relative to the first segment. Such segmentation facilitates bunching of the newly felled tree by the bunching arm 206.

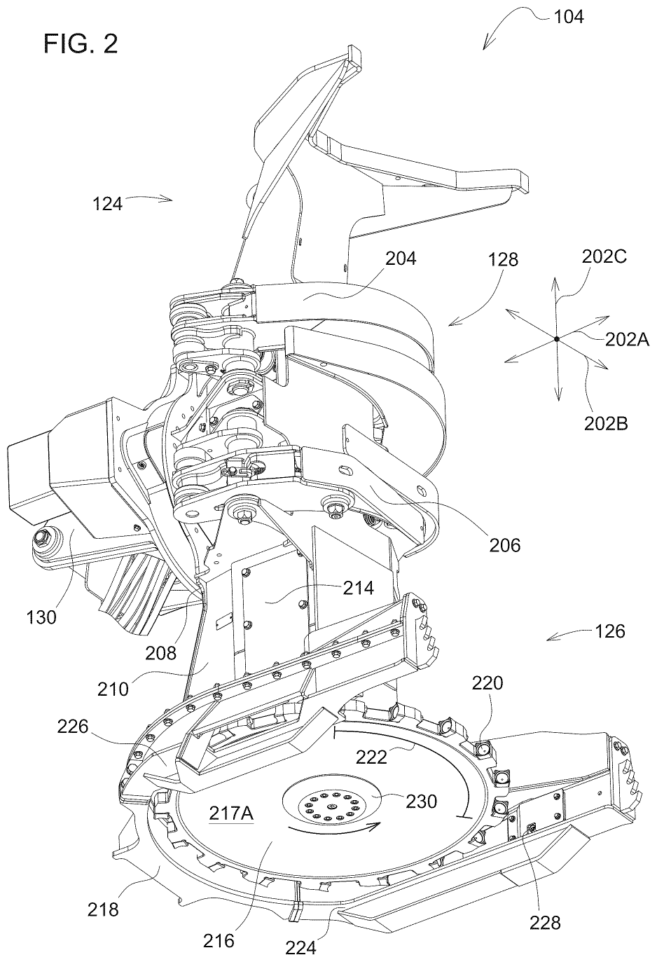

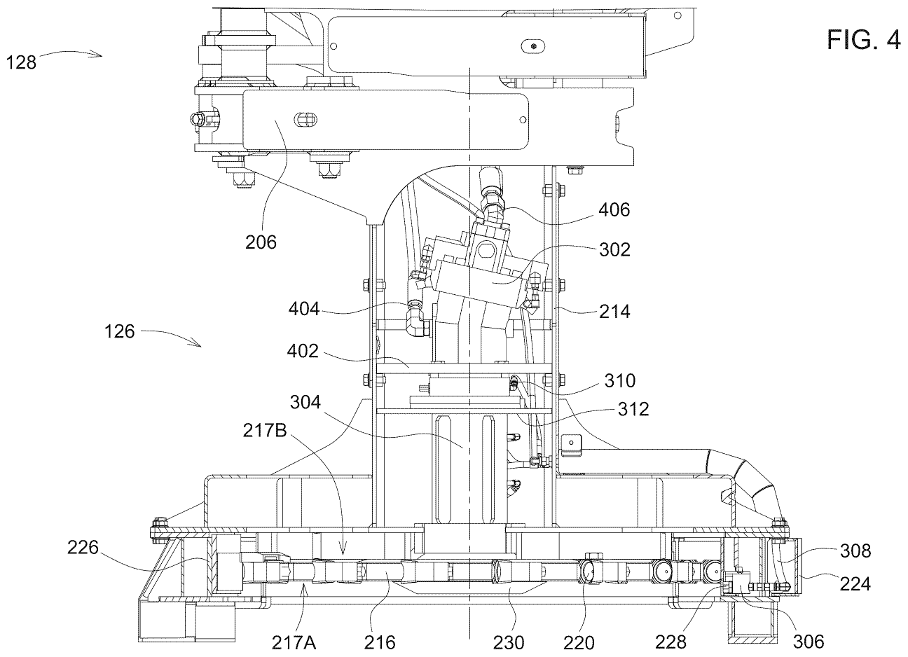

In the embodiment shown in FIGS. 2-4, saw head 126, or saw-and-motor section, includes a generally planar saw blade 216 configured for felling trees. Saw blade 216 is attached via a central hub 230 to the rotary output or drive shaft 304 of motor 302. As can be seen more clearly in FIG. 4, drive shaft 304 extends longitudinally along a central axis. Saw blade 216 has a central axis and extends transversely on its mount to drive shaft 304. The central axis of saw blade 216 is preferably coaxial with the central longitudinal axis of drive shaft 304. Motor 302 is enclosed within motor housing 214. Drive shaft 304 extends perpendicularly from an upper shaft side 217B of disk blade 216 which opposes the opposing stump side 217A of the saw blade. The saw blade 216 includes cutting teeth 220 spaced around its periphery to form a saw edge which rotates to cut through a tree. The saw edge separates the shaft side 217B from stump side 217A. A generally horseshoe shaped saw housing or saw guard 218 has a central curved section that wraps around part of the periphery of the saw blade to enclose and shroud a portion of the saw edge. The saw guard 218 shrouds portions of the saw edge to provide a barrier preventing contact between portions rotating saw edge not intended for cutting and objects that might otherwise inadvertently hit and be cut by the contact. Left branch 224 and right branch 226 of the horseshoe shaped saw guard 218 extend tangentially away from the saw blade to expose a cutting edge 222 which is a portion of the saw edge intended for cutting tree trunks and limbs.

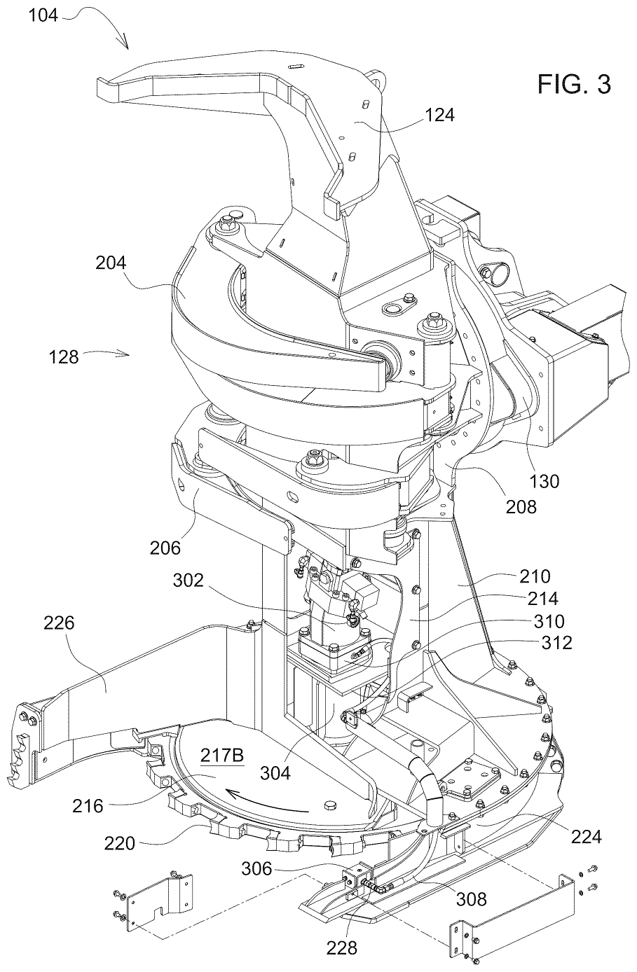

With motor 302 rotating saw blade 216, the operator can manipulate base vehicle 102, lift cylinders 114, pivot cylinders 118, and orient the based vehicle 102 to position felling head 104 so that cutting edge 222 contacts parts of a tree, such as the tree trunk. Rotating cutting teeth 220 can cut the tree as cutting edge 222 advances through the tree limb or trunk. As cutting edge 222 advances through the tree trunk, stump side 217A of the saw blade is adjacent to the remaining stump of the tree. In the embodiments shown in FIGS. 2, 3 and 4, motor 302 rotates saw blade 216 counterclockwise as viewed in FIGS. 2 and 3, and rotates the cutting teeth 220 from right to left as shown in FIG. 4. Thus, when motor 302 rotates saw blade 216, the cutting teeth 220 shrouded by left branch 224 are advancing towards cutting edge 222, while cutting teeth 220 shrouded by right branch 226 are returning from cutting edge 222.

Saw head can include a dispenser for dispensing a herbicidal fluid. Dispenser includes a dispenser outlet 228 for dispensing herbicide on the cut surface of the tree stump. Dispenser outlet 228 can be a spray nozzle located in the plane of the saw edge on left branch 224 of saw guard 218 and oriented to spray herbicide onto the advancing cutting teeth 220 of cutting edge 222 and thereby apply herbicide onto the cut surface of any tree stump saw blade 216 may cut. The dispenser can include a herbicide supply line 308 that delivers herbicide to dispenser outlet 228 from a herbicide reservoir which may be located on felling head 104 or on base vehicle 102. Supply line 308 can couple the herbicide reservoir to dispenser outlet 228 via a controller operated herbicide pump which operates to pump herbicide to dispenser outlet 228 at a desired pressure. An outlet valve 306 which can be operated by a controller to open and release herbicide and close to stop dispensing herbicide. Other known methods of delivering herbicide to cutting edge 222

FIGS. 3 and 4 show cutaway views of motor housing 214 of saw head 126. Hydraulic motor 302 is mounted on an upper deck 402 fixed at a mid-section of housing 214. An output shaft speed sensor 310 is attached to the bottom of motor 302 and, in operation, generates an output signal responsive to the current drive shaft speed of the rotary output or drive shaft 304 which couples motor 302 to saw blade 216. The output shaft speed sensor 310 can be mounted on a lower deck 312. Hydraulic lines 404 and 406 can supply hydraulic fluid pumped from and returning to a hydraulic system of the base vehicle 102. Controller operated valves between base vehicle 102 and the hydraulic motor can control the flow of hydraulic fluid powering motor 302. The valves can be on/off valves that operate the motor 302 to run at a predetermined set speed, such as at a drive shaft speed of 1175 rpm, when the saw blade 216 is rotating freely and is not cutting, i.e., under no load. However, when motor 302 is subject to a load, such as when operator manipulates base vehicle 102 and positions felling head 104 to bring the rotating cutting teeth 220 into contact with a tree, operating speed of motor 302 drops so that the current drive shaft speed is below the predetermined set or target speed. As the load on motor 302 decreases, the current drive shaft speed returns to its target speed.

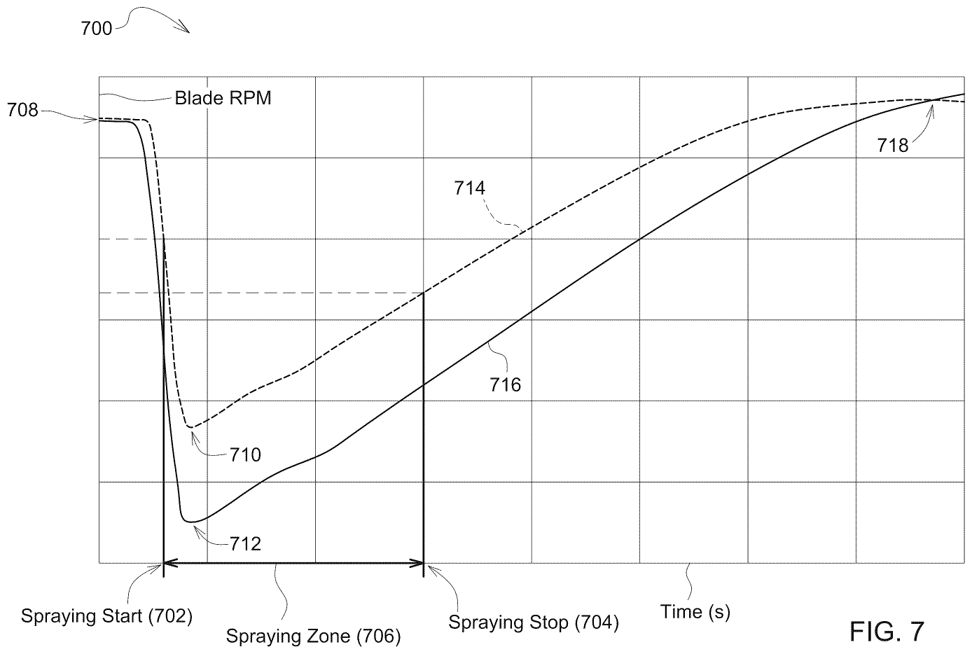

FIG. 7 includes a graph 700 showing various examples how current drive shaft speed (“Blade RPM” on the vertical axis) can vary with time (“Time (s)” on the horizontal axis) as saw blade 216 cuts through different trees. Motor 302 is rotating at a speed of 1175 rpm at the starting point 708 when there is no load on motor 302 and saw blade 216 is not cutting. The load on motor 302 increases as cutting edge 222 advances through the tree limb or trunk and the width of the cut increases so that more teeth 220 are actively in the cut at a given time. As shown by the different traces for Tree A 714 and Tree B 716, the load on motor 302 can also be affected by the hardness of the timber and the rate at which the operator advances cutting edge 222 through the tree. Thus, while cutting a tree trunk or limb, the current drive shaft speed can drop to a Tree A minimum value 710 and a Tree B minimum value 712. The current speed difference between the target speed and the current drive shaft speed can be greater than 20% for example. As cutting edge 222 continues to advance through the tree, the width of the cut again decreases along with the load on motor 302. As the load decreases, the speed of the motor increases and returns to the 1175 rpm target speed at the recovery 718 after cutting edge 222 has completed cutting.

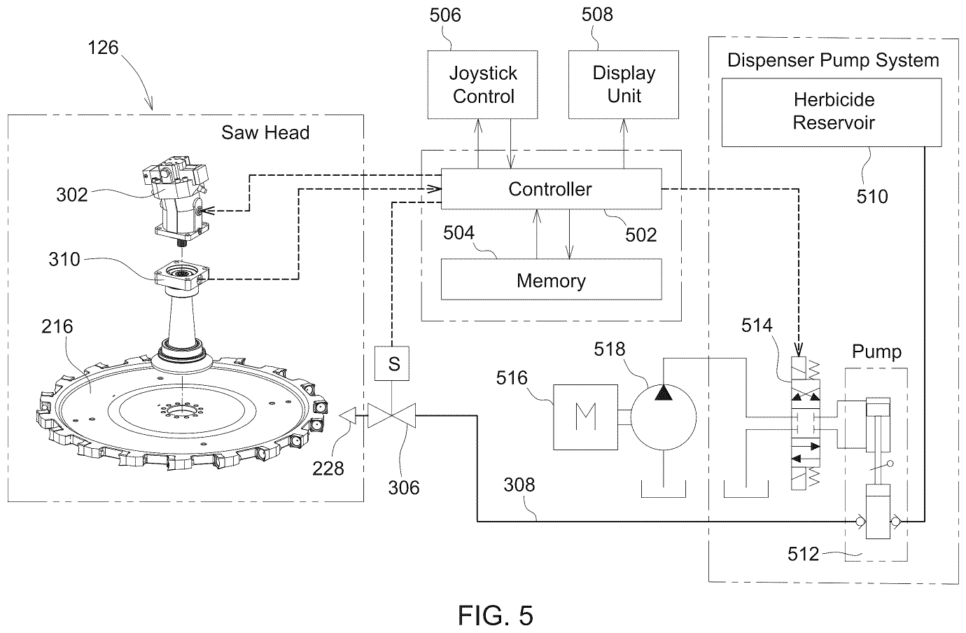

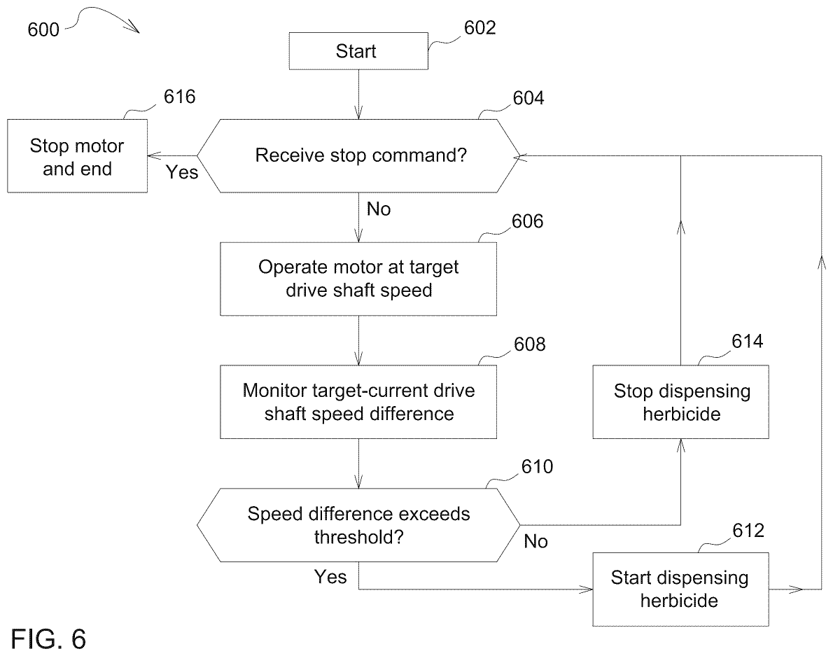

Saw head 126 is coupled to a control system for autonomously treating tree stumps. As schematically shown in FIG. 5, the control system includes a controller 502 which can be configured to perform the steps of the flow chart in FIG. 6 by programming with algorithms and software stored in memory 504. Display unit 508 can be coupled to receive display signals from controller 502 to display information relevant to the operator regarding operation of the forestry machine 100. Controller 502 can also be coupled to receive operator commands from joystick control 506 and also to transmit information and feedback to the operator concerning machine operation. Operator commands from joystick control 506 can include turning on or off rotation of saw blade 216 by starting or stopping motor 302 as well as commands to position felling head by raising, lowering, and pivoting the felling head 104, or by commands to drive and steer base vehicle 102 to a desired orientation. As shown by short, dashed lines, controller 502 can be connected to actuate valves to transmit hydraulic fluid to power or stop rotation of motor 302. Controller 502 is also communicatively coupled to receive signals from speed sensor 310 to monitor the current rotational speed of the output shaft of motor 302.

During a felling job, an operator may want to start motor 302 running and keep it running throughout the job. Continuously dispensing herbicide for the duration of the job can be inefficient, wasteful of the herbicidal fluid, and may limit the duration of the felling job to permit frequent resupply of depleted herbicide. An operator actuated dispensing system would require the operator to remember to dispense herbicide during each cut may result in multiple untreated stumps whenever the operator forgets to dispense herbicide.

Various embodiments of the present forestry machine 100 can assist by providing an autonomous system for treating tree stumps with herbicide during a felling job. In such embodiments, felling head 104 can be coupled to a dispensing system that includes a herbicide reservoir 510 which can be a tank for storing a quantity of herbicidal fluid located on base vehicle 102. Herbicide line 308 provides a fluid connection between herbicide reservoir 510 and herbicide pump 512. Herbicide pump can also be located on base vehicle 102 and can include an actuating piston coupled to a diaphragm located in a pump chamber. A solenoid operated directional valve 514 can receive command signals from controller 502 to control the flow of hydraulic fluid from the base vehicle's hydraulic system. The hydraulic system of base vehicle 102 can include a hydraulic pump 518 driven by a prime mover engine 516. The hydraulic pump 518 can be configured to pump hydraulic fluid through the hydraulic system of base vehicle 102, including through directional valve 514. The command signals directional valve 514 receives causes the actuating piston to retract and thereby cause the diaphragm to draw low pressure herbicide fluid from herbicide reservoir 510 through a first one-way valve into pump chamber. A second one-way valve at the outlet of the pump chamber prevents fluid in the herbicide line between the pump chamber and dispenser outlet 228 from being drawn backwards into the pump chamber when the actuating piston retracts. The command signals also extend the actuated piston and thereby cause the diaphragm to expel herbicide fluid at a higher pressure from the pump chamber through a second one-way valve at the chamber outlet. The first one-way valve at the pump chamber entrance prevents high pressure herbicide from flowing out of the chamber entrance. A second portion of herbicide line 308 fluidly connects the chamber outlet to a pray nozzle on saw head 126 at dispenser outlet 228. Optionally, herbicide line 308 can include near dispenser outlet 228 a solenoid-actuated outlet valve 306, which can be actuated by command signals from controller 502. The control system can optionally include flow or pressure control valves in addition to directional valve 514 which controller 502 can operate to adjust the flow rate at which herbicide pump 512 expels herbicide through dispenser outlet 228. In some embodiments, controller 502 can adjust the herbicide flow rate based factors such as the magnitude of the current speed difference.

Using algorithms and software stored in memory 504, controller 502 can be programmed and configured to autonomously treat tree stumps with a herbicide according to the steps described in flowchart 600 of FIG. 6. Controller 502 can receive a operator's start felling job command from joystick control 506 or some other operator interface in step 602. Before proceeding to operate motor 302, controller in step 604 checks whether it has received an operator command to stop felling. If no stop command has been received, in step 606 controller 502 transmits a command signal to controller operated motor valves to operate motor 302 at its predetermined set speed which rotates drives shaft 304 at a target drive shaft speed.

Using the speed signal that controller 502 receives from speed sensor 310, in step 608 controller 502 monitors the current drive shaft speed and calculates the difference between the target drive shaft speed and the current drive shaft speed. Because the current drive shaft speed and target drive shaft speed are proportional to the current sawing speed and target sawing speed controller 502 can use the current and target drive shaft speeds as measurements of current and target sawing speeds. Thus, the difference between the target drive shaft speed and the current drive shaft speed is representative of the current speed difference between the target sawing speed and current sawing speed. The current speed difference should be zero when motor 302 is under no load conditions. However, whenever cutting edge 222 contacts and begins to cut through a tree trunk, the load on the motor caused by the saw blade cutting through the tree reduces the current sawing speed below the target sawing speed under no load conditions. The current speed difference can be dependent on such factors as the width of the portion of the tree being cut and the hardness of its wood. As the cutting edge 222 cuts deeper into thicker portions of the tree of the tree limb or trunk, the load on motor 302 increases and the current speed difference increases.

Controller 502 monitors the current speed difference and queries whether it has reached a predetermined threshold value in step 610. The current speed difference can be at least 5% of the target drive shaft speed and, preferably, at least 10% of the target drive shaft speed. If the current speed difference has not yet reached the threshold, controller in step 614 controls directional valve 514 to operate pump 512 to draw herbicide into pump chamber but thereafter prevent further operation of pump 512 to expel the herbicide. Controller 502 can also send a command signal to close dispenser outlet solenoid valve 306. Thereafter controller 502 returns to step 604.

Alternatively, if in step 610 controller 502 determines that the current speed difference has reached the threshold value, in step 612 controller 502 sends a command signal to open outlet solenoid valve 306. In addition, controller 502 sends a command signal to directional valve 514 to operate pump 512 to expel herbicide from the pump chamber to dispense herbicide through the spray nozzle at dispenser outlet 228. This corresponds to Spraying Zone 706 in FIG. 7. The threshold value to start spraying can be set by controller 502 or set by the operator. In the examples shown in graph 700, this corresponds to current speed difference at Spraying Start 702. Because motor speed generally responds faster to applied loads and takes longer to recover no load target speed, the threshold to stop dispensing can be set to a different value to indicate when cutting edge 222 has reached the end of the cut and prevent wasting herbicide by continuing to dispense after the cut is complete. For example, the threshold to stop dispensing herbicide at Spraying Stop 704 can correspond to current speed difference at Spraying Start. Once the herbicide is dispensed, controller 502 operates directional valve 514 and pump 512 to draw herbicide into pump chamber. Thereafter, controller 502 proceeds to step 604. If in step 604 controller 502 has received a stop felling job command from joystick control 506 or some other appropriately configured operator interface, in step 616 controller 502 sends a command signal to the motor valves to stop the flow of hydraulic fluid to motor 302 to stop its operation.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A saw head for treating tree stumps, the saw head comprising:
a planar saw having a plurality of teeth along a saw edge, the saw edge separating a shaft side of the saw from a stump side, wherein the saw edge includes a cutting edge and the plurality of teeth include advancing teeth and returning teeth, wherein the plurality of teeth are coupled to a motor via a drive shaft on the shaft side, and wherein the motor is configured to drive the advancing teeth towards the cutting edge and the returning teeth away from the cutting edge with a target drive shaft speed,
a sensor configured to monitor a current drive shaft speed and to output a signal responsive to the current drive shaft speed;
a controller operated fluid dispenser configured to dispense a fluid adjacent to the cutting edge;
wherein the saw head is coupled to a controller communicatively coupled to receive the signal from the sensor and operatively coupled to operate the dispenser, the controller configured to dispense the fluid based on a current speed difference between the target drive shaft speed and the current drive shaft speed.

2. The saw head of claim 1, wherein the controller is configured to begin dispensing fluid when the current speed difference is at least 5% of the target drive shaft speed.

3. The saw head of claim 1, wherein the controller is configured to stop dispensing fluid when the current speed difference is greater than the current speed difference to start dispensing fluid.

4. The saw head of claim 1, further comprising a saw guard having a first branch shrouding advancing teeth and a second branch shrouding returning teeth, wherein the saw edge includes a guarded edge separate from the cutting edge, wherein the saw guard shrouds the guarded edge, and wherein the first branch includes a dispenser outlet.

5. The saw head of claim 4, wherein the motor drives the plurality of teeth in a cutting direction, and wherein the dispenser outlet is configured to spray the fluid in the cutting direction towards the cutting edge.

6. The saw head of claim 1, wherein the fluid is a herbicide.

7. The saw head of claim 1, wherein the dispenser includes a fluid reservoir fluidly coupled to a dispenser outlet.

8. The saw head of claim 7, wherein the dispenser further includes a pump configured to pump fluid from the fluid reservoir through the dispenser outlet.

9. The saw head of claim 8, wherein the controller is operatively coupled to the pump and configured to operate the pump to adjust a flow rate of the fluid dispensed through the dispenser outlet.

10. The saw head of claim 1, further comprising a controller operated valve operatively coupled to the controller, wherein the controller is configured to operate the valve to adjust a flow rate of fluid dispensed through the dispenser.

11. A saw head for treating tree stumps, the saw head comprising:
a frame which extends between an upper end and a lower end
a motor attached to the frame and coupled to rotate a drive shaft about a central longitudinal axis of the drive shaft at a target drive shaft speed, the drive shaft having a mount below the motor relative to the frame for fixedly attaching a transverse saw blade to rotate with the drive shaft;
a harvesting arm pivotally attached to the frame above the mount relative to the frame;
a harvesting cylinder coupled between the harvesting arm and frame and actuatable to pivot the harvesting arm transversely between an open and closed position;
a saw blade guard transversely mounted on the frame below the harvesting arm the saw blade guard extending transversely;
a sensor configured to monitor a current rotational speed of the motor and to output a signal responsive to the current speed of the motor;
a controller operated fluid dispenser configured to dispense a fluid through a dispenser outlet;
wherein the saw head is coupled to a controller communicatively coupled to receive the signal from the sensor and operatively coupled to operate the dispenser, the controller configured to dispense the fluid based on a current speed difference between the target drive shaft speed and the current drive shaft speed.

12. The saw head of claim 11, wherein the dispenser includes a dispenser outlet mounted on the guard.

13. The saw head of claim 11, wherein the controller is configured to dispense fluid when the current speed difference is at least 10% of the target drive shaft speed.

14. The saw head of claim 11, wherein the fluid is a herbicide.

15. The saw head of claim 11, wherein the dispenser includes a fluid reservoir fluidly coupled to the dispenser outlet.

16. The saw head of claim 15, wherein the dispenser further includes a pump configured to pump fluid from the fluid reservoir to the dispenser outlet.
